(19) United States
(12) Patent Application Publication
(10) Pub. No.: US 2024/0309124 A1
(43) Pub. Date: Sep. 19, 2024

(54) A COMPOSITION AND ITS APPLICATION IN CONTROLLED LIVING WATER-BASED EMULSION POLYMERIZATION

(71) Applicants: BASF SE, Ludwigshafen am Rhein (DE); Nanyang Technological University, Singapore (SG)

(72) Inventors: Bo PENG, Shanghai (CN); Atsushi GOTO, Singapore (SG); Weijia MAO, Singapore (SG); Jit SARKAR, Singapore (SG)

(21) Appl. No.: 18/578,248

(22) PCT Filed: Jun. 28, 2022
(86) PCT No.: PCT/CN2022/101879

§ 371 Date: Jan. 10, 2024

(30) Foreign Application Priority Data
Jul. 30, 2021 (WO) PCT/CN2021/109623

(51) Int. Cl. C08F 2/38; C08F 2/26; C08K 3/16

(52) U.S. Cl. CPC C08F 2/38; C08F 2/26; C08K 3/16; C08F 2438/00

(57) ABSTRACT

Described herein are a composition and its application in controlled living water-based emulsion polymerization. The composition includes at least one organic water-soluble iodine compound, optionally at least one organic-solvent-soluble iodide salt and/or optionally at least one water-soluble iodide salt. When applied in controlled living water-based emulsion polymerization, the resulting polymer shows low PDI and the polymer particle also has a low size PDI.

### FIELD OF INVENTION

The present invention is related to a composition and its application in controlled living water-based emulsion polymerization.

### BACKGROUND OF THE INVENTION

Free-radical polymerization technique has been widely used in emulsion polymerization. It is capable of accepting the least stringent experimental conditions and the widest range of monomers. However, one major limitation of conventional free-radical polymerization originates in the decisive significance of the irreversible termination reactions via combination and/or dismutation of the free radicals assuring the growth of the chains. Due to such limitation, many of the polymers synthesized via the conventional free-radical polymerization have a wide polydisperse index (PDI). When the conventional free-radical polymerization is applied in emulsion polymerization, the synthesized polymer particles show significant variation in particle diameter.

Recently, emulsion polymerization has been combined with living radical polymerization (LRP) techniques. However, drawbacks of existing controlled radical polymerization (CRP) techniques are the presence of toxic heavy metal complexes (so-called ATRP technique) and sulfur compounds with a very unpleasant odor (so-called RAFT polymerization). The combination of emulsion polymerization with ATRP and RAFT polymerizations has been established, but the obtained particles contain toxic heavy metal complexes and/or very unpleasant odor.

More recently, living polymerization technology utilizing iodide compounds has been developed. EP2147936B1 discloses a composition for use in a living polymerization which comprises a catalyst, a radical initiator and an organic halide. Such composition is useful for the synthesis of polymers with low PDI. However, such composition has not been proved to be useful in emulsion polymerization.

EP272698 disclosed iodine transfer polymerization (ITP) technique. By using an initiating radical, iodofluorocompounds could enter in a controlled process, based on a degenerative transfer. However, it is silent about which iodocompounds are suitable for use in emulsion polymerization.

Meanwhile, the reverse iodine transfer polymerization (RITP) technique, which employs iodine as a control agent, has been developed. US 20090306302A discloses a method of free-radical polymerization in aqueous dispersion, which applies molecular iodine and at least one oxidizing agent whose solubility in water is at least 10 g/l. However, the use of molecular iodine limits its application scope.

There is still a need to develop new compositions and methods that can be applied in water based living radical emulsion polymerization.

### SUMMARY OF THE INVENTION

One objective of the present invention is to provide a composition comprising:
A) At least one organic water-soluble iodine compound, optionally
B) At least one organic-solvent-soluble iodide salt, and/or optionally
C) At least one water-soluble iodide salt,

Wherein the at least one organic water-soluble iodine compound A) is represented by formula (1)

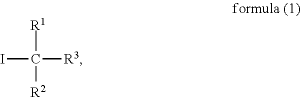

wherein R¹ is —COOX or —CONR⁴R⁵, and X is a hydrogen atom, an alkali metal, an alkaline earth metal, an organic ammonium, an ammonium, (CH₂CHR⁴O)ₙR⁵, (CH₂CHR⁴O)ₙ(CH₂CHR⁶O)ₘR⁵, n and m are independent of each a integer number in the range of 1 to 500, and R², R³, R⁴, R⁵ and R⁶ are independently of each other a hydrogen, an alkoxyl group/alkoxyl derivative, an aromatic group/aromatic derivative, and an aliphatic group/aliphatic derivative. Meanwhile, R⁴ and R⁶ shall be different.

Another objective of the present invention is to provide the use of such composition in controlled living water-based emulsion polymerization.

### DETAILED DESCRIPTION OF THE INVENTION

Unless otherwise specified, all terms/terminology/nomenclatures used herein have the same meaning as commonly understood by the skilled person in the art to which this invention belongs to.

Expressions “a”, “an” and “the”, when used to define a term, include both the plural and singular forms of the term.

The term “polymer” or “polymers”, as used herein, includes both homopolymer(s), that is, polymers prepared from a single reactive compound, and copolymer(s), that is, polymers prepared by reaction of at least two polymer forming reactive, monomeric compounds.

The term “salt” means a chemical compound consisting of an ionic assembly of cations and anions.

The term “water-soluble” means a compound has a water-solubility of at least 0.8 g/L in water at 22° C. and 1 atm. And, the term “organic-solvent-soluble” means a compound has a solubility of at least 20 g/L in acetone at 22° C. and 1 atm.

The term “derivative” means compound that is derived from a similar compound with one or more hydrogen atoms been substituted with a function group, such as a halogen, a carboxylate group, an alkoxyl group, an ester group, an thioester group, etc.

The designation (meth)acrylate and similar designations are used herein as an abbreviated notation for “acrylate and/or methacrylate”.

The term weight average molecular weight (Mw) means a molecular weight measured by Gel Permeation Chromatography (GPC) against poly(methyl methacrylate) or polystyrene standard in dimethylformamide with the unit of g/mol.

All percentages and ratios denote weight percentages and weight ratios unless otherwise specified.

One objective of the present invention is to provide a composition comprising:
A) At least one organic water-soluble iodine compound, optionally
B) At least one organic-solvent-soluble iodide salt, and/or optionally
C) At least one water-soluble iodide salt,

Wherein the at least one organic water-soluble iodine compound A) is represented by formula (1)

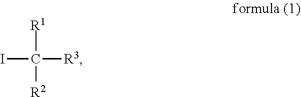

wherein R1 is-COOX or —CONR⁴R⁵, and X is a hydrogen atom, an alkali metal, an alkaline earth metal, an organic ammonium, an ammonium (CH₂CHR⁴O)ₙR⁵, (CH₂CHR⁴O)ₙ(CH₂CHR⁶O)ₘR⁵, n and m are independent of each a integer number in the range of 1 to 500, and R², R³, R⁴, R⁵ and R⁶ are independently of each other a hydrogen, an alkoxyl group/alkoxyl derivative, an aromatic group/aromatic derivative, and an aliphatic group/aliphatic derivative. Meanwhile, R⁴ and R⁶ shall be different.

Unexpectedly, it was found that when a composition of the current disclosure is used in a water-based emulsion polymerization process, the resulting polymer shows narrow PDI and the emulsion particles have a narrow size PDI as well.

The at least one organic water-soluble iodine compound A) may be represented by formula 1)

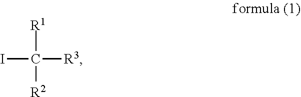

wherein R1 is —COOX or —CONR⁴R⁵, and X is a hydrogen atom, an alkali metal, an alkaline earth metal, an organic ammonium, an ammonium, (CH₂CHR⁴O)ₙR⁵, (CH₂CHR⁴O)ₙ(CH₂CHR⁶O)ₘR⁵, (CH₂)ₙOH, (CHR⁴)ₙOH, n and m are independent of each a integer number in the range of 1 to 500, and R², R³, R⁴, R⁵ and R⁶ are independently of each other a hydrogen, an alkyl group/alkyl derivative, an alkoxyl group/alkoxyl derivative, and an aryl group/aryl derivative. Meanwhile, R⁴ and R⁶ shall be different.

Examples of an alkali metal include, but not limited to, Li, Na and K; examples of an alkaline earth metal include, but not limited to, Be, Mg and Ca; examples of an organic ammonium include, but not limited to, trimethylammonium, tetramethylammonium, triethylammonium, ethyltrimethylammonium, tetraethyl ammonium, etc.

Examples of (CH₂CHR⁴O)ₙR⁵ may include, but not limited to, (CH₂CH₂O)ₙH, (CH₂CH₂O)ₙCH₃, (CH₂CH(CH₃)O)ₙH and (CH₂CH(CH₃)O)ₙCH3, wherein n is a integer number in the range of 1 to 500, preferably in the range of 1 to 200, more preferable 1 to 150, and most preferably 1 to 100.

Examples of (CH₂CHR⁴O)ₙ(CH₂CHR⁶O)ₘR⁵ may include, but not limited to, (CH₂CH₂O)ₙ(CH₂CH(CH₃)O)ₘH, (CH₂CH(CH₃)O)ₙ(CH₂CH₂O)ₘH, (CH₂CH₂O)ₙ—(CH₂CH(CH₃)O)ₘCH₃, (CH₂CH(CH₃)O)ₙ(CH₂CH₂O)ₘCH₃, wherein n and m are independent of each a integer number in the range of 1 to 500, preferably in the range of 1 to 200, more preferably in the range of 1 to 150, and most preferably in the range of 20 to 100.

Example of (CH₂)ₙOH and (CHR⁴)ₙOH may include, but not limited to, CH₂CH₂OH, CH₂CH₂CH₂OH, CH₂CH₂CH₂CH₂OH, CH₂CH(CH₃)OH and (CH₂CH(CH₃))₂OH.

In a preferred embodiment, R¹ is selected from COOH, COOCH₂CH₂OH and COO(CH₂CH₂O)ₙCH₃, wherein n is a integer number in the range of 50 to 100.

R² and R³ are independently of each other a hydrogen, an alkyl group/alkyl derivative, an alkoxyl group/alkoxyl derivative, and an aryl group/aryl derivative.

In the present invention, an “alkyl” refers to a monovalent group which is generated after a chain or cyclic aliphatic hydrocarbon (alkane) loses a hydrogen atom. In the cases of a chain alkyl group, the alkyl group is generally represented by CₖH₂ₖ₊₁ (wherein, k is a positive integer). A chain alkyl group may be a straight chain or branched chain. A cyclic alkyl group may be consisted of a cyclic structure. A cyclic alkyl group may have a structure in which a chain alkyl group is linked to the cyclic structure. An alkyl group may have an arbitrary natural number of carbon atoms. Preferably, an alkyl group has 1 to 30 carbon atoms. More preferably, an alkyl group has 1 to 20 carbon atoms.

In a preferred embodiment, a “lower alkyl” is preferred, which refers to an alkyl group having a relatively small number of carbon atoms. Preferably, a lower alkyl is a C₁₋₁₀ alkyl group. More preferably, a lower alkyl is a C₁₋₅ alkyl group. Further preferably, a lower alkyl is a C₁₋₃ alkyl group. For instance, specific examples include methyl, ethyl, propyl and isopropyl.

In the present specification, an “alkoxy” refers to a group in which an oxygen atom is bound to the aforementioned alkyl group. That is, when the alkyl group is represented by R—, the alkoxy refers to a group represented by RO—. A chain alkoxy group may be a straight chain or branched chain. Cyclic alkoxy may be composed only of a cyclic structure, or may have a structure formed from a cyclic structure further linked with chain alkyl. The number of carbon atoms in the alkoxy may be any natural number. The number of carbon atoms is preferably from 1 to 30, and more preferably from 1 to 20.

In a preferred embodiment, a “lower alkoxy” is preferred, which refers to an alkoxy group having relatively fewer carbon atoms. The lower alkoxy is preferably C₁₋₁₀ alkoxy, more preferably C₁₋₅ alkoxy, and even more preferably C₁₋₃ alkoxy. Specific examples thereof include methoxy, ethoxy, butoxy or isopropoxy.

In the present invention, an “aryl” refers to a group which is generated after a hydrogen atom, which is bound to a ring of an aromatic hydrocarbon, is removed. Specifically, for example, an aryl includes a phenyl group, naphthyl group, or anthracenyl group.

In a preferred embodiment, a “substituted aryl” is preferred, which refers to a group which is generated after a substituent binds to an aryl group.

In the present invention, a “halogen” refers to a monovalent radical of an element, which belongs to the 7B group of the periodic table, such as a fluorine (F), chlorine (Cl), bromine (Br) and iodine (I). A “carboxylate” refers to a “alkylcarboxyl” or a “alkylcarbonyl”. An “alkylcarboxyl” refers to a group in which a carboxyl group is bound to the aforementioned alkyl group. That is, when the alkyl group is represented by R—, the alkylcarboxyl refers to a group represented by RCOO—. A chain alkylcarboxyl group may be a straight chain or branched chain. A cyclic alkylcarboxyl group may be composed only of a cyclic structure, or may have a structure formed from a cyclic structure further linked with chain alkyl. The number of carbon atoms in the alkylcarboxyl may be any natural number. The number of carbon atoms is preferably from 1 to 30, and more preferably from 1 to 20. An “alkylcarbonyl” refers to a group in which a carbonyl group is bound to the aforementioned alkyl group. That is, when the alkyl group is represented by R—, the alkylcarbonyl refers to a group represented by RCO—. A chain alkylcarbonyl group may be a straight chain or branched chain. Cyclic alkylcarbonyl may be composed only of a cyclic structure, or may have a structure formed from a cyclic structure further linked with chain alkyl. The number of carbon atoms in the alkylcarbonyl may be any natural number. The number of carbon atoms is preferably from 1 to 30, and more preferably from 1 to 20.

In a preferred embodiment, if a “carboxylate” is presented, a “lower alkylcarboxyl” and/or a “lower alkylcarbonyl” is preferred as the R² and/or R³. A “lower alkylcarboxyl” refers to an alkylcarboxyl group having relatively fewer carbon atoms. The lower alkylcarboxyl is preferably C₁₋₁₀ alkylcarboxyl, more preferably C₁₋₅ alkylcarboxyl, and even more preferably C₁₋₃ alkylcarboxyl. A “lower alkylcarbonyl” refers to an alkylcarbonyl group having relatively fewer carbon atoms. The lower alkylcarbonyl is preferably C₁₋₁₀ alkylcarbonyl, more preferably C₁₋₅ alkylcarbonyl, and even more preferably C₁₋₃ alkylcarbonyl.

In a preferred embodiment, R¹ is selected from COOH, COONa, COOK, COONH₄, COO(Ca)_{0.5}, CONH₂, COCH₂CH₂OH and CO(CH₂CH₂O)ₙMe, wherein n is an integer in the range of 20 to 100, while R² and R³ are, independently of each other, selected from H, phenyl group, methyl group, ethyl group, propyl group and butyl group.

Among the iodine compounds represented by the general formula (1), iodine compounds may have a solubility in water of at least 0.8 g/L at 22° C. and 1 atm, preferably a solubility in water of at least 1.5 g/L at 22° C. and 1 atm, more preferably a solubility in water of at least 2 g/L at 22° C. and 1 atm, and most preferably a solubility in water of at least 3 g/L at 22° C. and 1 atm. Such compounds may include, but not limited to, 2-iodoacetic acid, 2-iodopropionic acid, 2-iodopropionic acid amide, 2-iodo-2-methylpropionic acid, poly(ethylene glycol) methyl ether 2-iodoisobutyrate, 2-iodo-2-methylpropionic acid amide, sodium 2-iodo-2-methylpropionate, calcium 2-iodo-2-methylpropionate, ammonium 2-iodo-2-methylpropionate, 2-hydroxyethyl 2-iodo-2-methylpropionate, 2-iodopentanoic acid, 2,5-diiodoadipic acid, α-iodo-β-butyrolactone, sodium 2-iodo-2-phenylacetate, calcium 2-iodo-2-phenylacetate, ammonium 2-iodo-2-phenylacetate, and 2-hydroxyethyl 2-iodo-2-phenylacetate.

The above iodine compounds represented by the general formula (1) may be used singly or two or more species thereof may be used in combination. The molecular weight controlling agent for radical polymerization of the present invention may use the above-mentioned iodine compound as it is, and may take the form of liquid, powder, solid or the like as required. Moreover, it may take the form of an aqueous solution, encapsulation etc. as necessary. In addition, various additives such as stabilizers and dispersing agents may be incorporated as necessary. Among these forms, it is preferable to take a liquid or powdery form from the viewpoint of handling, and more preferable to take an aqueous solution form.

The at least one organic-solvent-soluble iodide salt B) may be an iodide salt of an organic cation and iodide anion. In one embodiment, the organic cation may be a quaternary ammonium of the formula 2:

[N(R^{a})(R^{b})(R^{c})(R^{d})]⁺ (formula 2)

or a quaternary phosphonium of the formula 3:

[P(R^{a})(R^{b})(R^{c})(R^{d})]⁺ (formula 3),

wherein Ra, Rb, Rc and Rd are, independent of each other, an alkyl group/alkyl derivative, an alkoxyl group/alkoxyl derivative, and an aryl group/aryl derivative. The definition of “alkyl group/alkyl derivative”, “alkoxyl group/alkoxyl derivative”, and “aryl group/aryl derivative” may have the same meaning as described in the previous paragraph.

In a preferred embodiment, the exemplary compounds of quaternary ammonium of the formula 2 may include, but not limited to, acetylcholine iodide, acetylthiocholine iodide, benzoylcholine iodide, benzoylthiocholine iodide, benzyltriethylammonium iodide, n-butyrylcholine iodide, n-butyrylthiocholine iodide, decamethonium iodide, N,N-dimethylmethyleneammonium iodide, ethyltrimethylammonium iodide, ethyltri-n-propylammonium iodide, (ferrocenylmethyl)trimethylammonium iodide, (2-Hydroxyethyl)-triethylammonium iodide, Beta-methylcholine Iodide, O-beta-Naphthyloxycarbonylcholine iodide, phenyltriethylammonium iodide, phenyltrimethylammonium iodide, tetra-n-amylammonium iodide, tetra-butylammonium iodide, tetraethylammonium iodide, tetra-n-heptylammonium iodide, tetra-n-hexylammonium iodide, tetramethylammonium iodide, tetra-n-octylammonium iodide, tetra-n-propylammonium Iodide, 3-(trifluoromethyl)-phenyltrimethylammonium iodide. The exemplary compounds of quaternary phosphonium of formula 3 may include, but not limited to, trimethyl-n-dodecyl phosphonium iodide, triethyl-n-decyl phosphonium iodide, tri-n-propyl-n-tetradecyl phosphonium iodide, trimethylol-n-hexadecyl phosphonium iodide, tributylmethyl phosphonium iodide, tri-n-butyl-n-decyl phosphonium iodide, tri-n-butyl-n-dodecyl phosphonium iodide, tri-n-butyl-n-tetradecyl phosphonium iodide, tri-n-butyl-n-hexadecyl phosphonium iodide, tri-n-hexyl-n-decyl phosphonium iodide, triphenyl-n-dodecyl phosphonium iodide, triphenyl-n-tetradecyl phosphonium iodide and triphenyl-n-octadecyl phosphonium iodide.

The least one organic-solvent-soluble iodide salt B) may have a solubility of at least 20 g/L in acetone at 22° C. and 1 atm, preferably a solubility of at least 30 g/L in acetone at 22° C. and 1 atm, more preferably a solubility of at least 40 g/L in acetone at 22° C. and 1 atm, and most preferably a solubility of at least 50 g/L in acetone at 22° C. and 1 atm.

In a preferred embodiment, the at least one organic-solvent-soluble iodide salt B) is selected from tetra-butylammonium iodide, tributylmethyl phosphonium iodide and tetra-n-octylammonium iodide.

At least one water-soluble iodide salt C) may be an iodide salt of an alkali metal/alkaline earth metal/ammonium (NH₄) cation and iodide anion. In a preferred embodiment, the exemplary compounds of iodide salt of an inorganic cation and iodide anion may include, but not limited to, lithium iodide, sodium iodide, potassium iodide, calcium iodide and ammonium iodide.

The weight ratio of A), B) and C) may be in the ratio of 1:(0.1-40):(0.1-10), preferably in the ratio of 1:(1-20):(0.4-8), more preferably in the ratio of 1:(1-5):(0.4-2).

In a preferred embodiment, the at least one organic water-soluble iodine compound A) is selected from 2-iodoacetic acid, 2-iodopropionic acid, 2-iodopropionic acid amide, 2-iodo-2-methylpropionic acid, poly(ethylene glycol) methyl ether 2-iodoisobutyrate, 2-hydroxyethyl 2-iodoisobutyrate, 2-Iodo-2-phenylacetate, 2-iodo-2-phenylacetic acid; the at least one organic-solvent-soluble iodide salt B) is selected from tetra-butylammonium iodide, tributylmethyl phosphonium iodide and tetra-n-octylammonium iodide; and at least one water-soluble iodide salt C) may be selected from sodium iodide and potassium iodide. In such an embodiment, the at least one organic water-soluble iodine compound A) is presented in an amount of 2% to 85% by weight, the at least one organic-solvent-soluble iodide salt B) is presented in an amount of 8% to 80% by weight and the at least one water-soluble iodide salt C) may be presented in an amount of 8% to 20% by weight, all based on the total weight of the composition.

The composition of the current disclosure may be used in polymerization of many polymerizable monomers. Such monomers may include, but not limited to, (meth)acrylate monomers, (meth)acrylonitrile monomers, styrene monomers, vinyl alkanoate monomers, monoethylenically unsaturated di- and tricarboxylic ester monomers, a monoethylenically unsaturated monomers containing at least one functional group selected from a group consisting of carboxyl, carboxylic anhydride, sulfonic acid, phosphoric acid, hydroxyl and amide or a mixture thereof. These polymerizable monomers may be presented alone or in combination with other polymerizable monomers.

The (meth)acrylate monomers, may be C₁-C₁₉-alkyl (meth)acrylates, for example, but not limited to, methyl (meth)acrylate, ethyl (meth)acrylate, n-butyl (meth)acrylate, 2-ethylhexyl (meth)acrylate, cyclohexyl (meth)acrylate, n-octyl (meth)acrylate, n-decyl (meth)acrylate, n-dodecyl (meth)acrylate (i.e. lauryl (meth)acrylate), tetradecyl (meth)acrylate, oleyl (meth)acrylate, palmityl (meth)acrylate, stearyl (meth)acrylate, isobornyl (meth)acrylate, benzyl (meth)acrylate, phenyl (meth)acrylate and a mixture thereof.

The styrene monomers may be unsubstituted styrene or C₁-C₆-alkyl substituted styrenes, for example, but not limited to, styrene, α-methylstyrene, ortho-, meta- and para-methylstyrene, ortho-, meta- and para-ethylstyrene, o,p-dimethylstyrene, o,p-diethylstyrene, isopropylstyrene, o-methyl-p-isopropylstyrene or any mixture thereof.

The vinyl alkanoate monomers may include, but not limited to, vinyl esters of C₂-C₁₁-alkanoic acids, for example, but not limited to, vinyl acetate, vinyl propionate, vinyl butanoate, vinyl valerate, vinyl hexanoate, vinyl versatate or a mixture thereof.

The monoethylenically unsaturated di- and tricarboxylic ester monomers may include, but not limited to, be full esters of monoethylenically unsaturated di- and tricarboxylic acids, for example, but not limited to, diethyl maleate, dimethyl fumarate, ethyl methyl itaconate, dihexyl succinate, didecyl succinate or any mixture thereof.

The monoethylenically unsaturated monomers containing at least one functional group selected from a group consisting of carboxyl, carboxylic anhydride, sulfonic acid, phosphoric acid, hydroxyl and amide may include, but not limited to, monoethylenically unsaturated carboxylic acids, such as (meth)acrylic acid, itaconic acid, fumaric acid, citraconic acid, sorbic acid, cinnamic acid, glutaconic acid and maleic acid; monoethylenically unsaturated carboxylic anhydrides, such as itaconic acid anhydride, fumaric acid anhydride, citraconic acid anhydride, sorbic acid anhydride, cinnamic acid anhydride, glutaconic acid anhydride and maleic acid anhydride; monoethylenically unsaturated amides, such as (meth)acrylamide, N-methylol (meth)acrylamide, N,N-dimethylacrylamide (DMA), 2-hydroxyethyl (meth)acrylamide, dimethylaminoethylmethacrylamide; hydroxyalkyl esters of monoethylenically unsaturated carboxylic acids, such as hydroxyethyl (meth)acrylate and hydroxypropyl (meth)acrylate; and other monomers, such as glycerol (meth)acrylate, or a mixture thereof.

The monomers could further include other suitable polymerizable compounds, which include, but not limited to, olefins, such as ethylene, propene, chloropropene, butene, 1-decene; dienes, such as butadiene, isoprene, chloroprene, norbornadiene; N-vinyl compounds, such as N-vinyl-2-pyrrolidone (NVP), N-vinyl formamide, N-vinyl acetamide, N-vinyl isopropylamide, N-vinyl-N-methyl acetamide and N-vinyl caprolactam.

There can be crosslinking monomers presented in the monomer composition for both the core polymer and the shell polymer, which can be chosen from di- or poly-isocyanates, polyaziridines, polycarbodiimide, polyoxazolines, glyoxals, malonates, triols, epoxy molecules, organic silanes, carbamates, diamines and triamines, hydrazides, carbodiimides and multi-ethylenically unsaturated monomers. In the present invention, suitable crosslinking monomers include, but not limited to, glycidyl (meth)acrylate, N-methylol(meth)acrylamide, (isobutoxymethyl)acrylamide, vinyltrialkoxysilanes such as vinyltrimethoxysilane; alkylvinyldialkoxysilanes such as dimethoxymethylvinylsilane; (meth)acryloxyalkyltrialkoxysilanes such as (meth)acryloxyethyltrimethoxysilane, (3-acryloxypropyl)trimethoxysilane and (3-methacryloxypropyl)trimethoxysilane, allyl methacrylate, diallyl phthalate, 1,4-butylene glycol dimethacrylate, 1,2-ethylene glycol dimethacrylate, 1,6-hexanediol diacrylate, divinyl benzene or any mixture thereof.

The at least one organic water-soluble iodine compound A) may be used alone or with two or more species thereof may be used in combination. And, the at least one organic water-soluble iodine compound A) may be used in an amount, based on the total weight of monomers, 0.001% to 30% by weight, preferably 0.01% to 5% by weight, more preferably 0.1% to 3% by weight, and most preferably 0.3% to 3% by weight.

The at least one organic-solvent-soluble iodide salt B) may be used alone or with two or more species thereof may be used in combination. And, the at least one organic-solvent-soluble iodide salt B may be presented in an amount of, based on the total weight of monomers, 0.01% to 40% by weight, preferably 0.1% to 15% by weight, more preferably 1% to 10% by weight, and most preferably 3% to 7% by weight.

The at least one water-soluble iodide salt C) may be used alone or with two or more species thereof may be used in combination. And, the at least one water-soluble iodide salt C) may be presented in an amount of, based on the total weight of monomers, 0.01% to 40% by weight, preferably 0.01% to 10% by weight, more preferably 0.5% to 5% by weight, and most preferably 1% to 4% by weight.

During the polymerization process, most surfactants known to the skilled person in the art may be used. Surfactant to be used according to the present invention may be a non-reactive surfactant, a reactive surfactant or a combination thereof. Surfactants may be formulated together with the monomers and fed into a reaction reactor. Alternatively, the surfactants may be added into the reaction medium first followed by the feeding of monomers. Surfactants may be used in a suitable amount known to the skilled person in the art, for example, in a total amount of 0.1% to 6% by weight, based on the total weight of the monomers.

Surfactants may be non-reactive anionic and/or nonionic surfactants. Suitable non-reactive anionic surfactants, for example, include, but are not limited to, alkyl, aryl or alkylaryl sulfate salts, sulfonate salts or phosphate salts; alkyl sulfonic acids; sulfosuccinate salts; fatty alcohol ether sulfate salts and fatty acids. Suitable non-reactive nonionic surfactants for example include alcohol or phenol ethoxylates such as polyoxyethylene alkylphenyl ether.

Surfactants may also be polymerizable surfactants, also called a reactive surfactant, containing at least one ethylenically unsaturated functional group. Suitable polymerizable surfactants include, but are not limited to, allyl polyoxyalkylene ether sulfate salts such as sodium salts of allyl polyoxyethylene alkyl ether sulfate, allyl alkyl succinate sulfonate salts, allyl ether hydroxyl propanesulfonate salts such as sodium salts, polyoxyethylene styrenated phenyl ether sulfate salts such as ammonium salts, for example DKS Hitenol® AR 1025 and DKS Hitenol® AR 2020, polyoxyethylene alkylphenyl ether sulfate ammonium salts, polyoxyethylene allyloxy nonylphenoxypropyl ether, and phosphate acrylates such as SIPOMER® PAM 100, phosphate acrylates such as SIPOMER® PAM 200, etc.

The emulsion polymerization may be carried out in the presence of various common initiating systems, including but not limited to a thermal or redox initiator. The initiator is usually used in an amount of no more than 10% by weight, preferably 0.02 to 5% by weight, more preferably 0.1 to 1.5 wt %, based on the total weight of the two stage monomers.

Suitable initiators may be used include, but are not limited to, inorganic peroxides, such as hydrogen peroxide, or peroxodisulfates, or organic peroxides, such as tert-butyl, p-menthyl or cumyl hydroperoxide, tert-butyl perpivalate, and dialkyl or diaryl peroxides, such as di-tert-butyl or di-cumyl peroxide. Azo compounds which may be used, include, but not limited to, 2,2′-azobis(isobutyronitrile), 2,2′-azobis(2,4-dimethylvaleronitrile). Among others, sodium persulfate (SPS), potassium persulfate (KPS), ammonium persulfate (APS), 2,2′-azobis(amidinopropyl) dihydrochloride (AIBA, V-50 ™), and 4,4′-azobis(4-cyanovaleric acid) (ACVA, V501) are preferred as the thermal initiator.

A redox initiator usually comprises an oxidizing agent and a reducing agent. Suitable oxidizing agents include the abovementioned peroxides. Suitable reducing agents may be alkali metal sulfites, such as potassium and/or sodium sulfite, or alkali metal hydrogensulfites, such as potassium and/or sodium hydrogensulfite. Preferable redox initiators include an oxidizing agent selected from the group consisting of t-butylhydroperoxide and hydrogen peroxide, and a reducing agent selected from ascorbic acid, sodium formaldehyde sulfoxylate, sodium acetone bisulfite and sodium metabisulfite (sodium disulfite).

In an emulsion polymerization process, most surfactants known to the skilled person in the art may be used. Surfactant to be used according to the present invention may be a non-reactive surfactant, a reactive surfactant or a combination thereof. Surfactants may be formulated together with the monomers and fed into a reaction reactor. Alternatively, the surfactants may be added into the reaction medium first followed by the feeding of monomers. Surfactants may be used in a suitable amount known to the skilled person in the art, for example, in a total amount of 0.1% to 6% by weight, based on the total weight of the monomers.

Surfactants may be non-reactive anionic and/or nonionic surfactants. Suitable non-reactive anionic surfactants, for example, include, but are not limited to, alkyl, aryl or alkylaryl sulfate salts, sulfonate salts or phosphate salts; alkyl sulfonic acids; sulfosuccinate salts; fatty alcohol ether sulfate salts and fatty acids. Suitable non-reactive nonionic surfactants for example include alcohol or phenol ethoxylates such as polyoxyethylene alkylphenyl ether.

Surfactants may also be polymerizable surfactants, also called reactive surfactants, containing at least one ethylenically unsaturated functional group. Suitable polymerizable surfactants for example include, but are not limited to, allyl polyoxyalkylene ether sulfate salts such as sodium salts of allyl polyoxyethylene alkyl ether sulfate, allyl alkyl succinate sulfonate salts, allyl ether hydroxyl propanesulfonate salts such as sodium salts, polyoxyethylene styrenated phenyl ether sulfate salts such as ammonium salts, for example DKS Hitenol AR 1025 and DKS Hitenol AR 2020, polyoxyethylene alkylphenyl ether sulfate ammonium salts, polyoxyethylene allyloxy nonylphenoxypropyl ether, and phosphate acrylates such as SIPOMER PAM 100, phosphate acrylates such as SIPOMER PAM 200, etc.

The polymerization may be carried out and maintained at a temperature lower than 100° C. throughout the course of the reaction. Preferably, the polymerization is carried out at a temperature between 60° C. and 95° C. Depending on various polymerization conditions, the polymerization may be carried out for several hours, for example 0.5 to 8 hours.

An organic base and/or inorganic base may be added into the polymerization system as a neutralizer during the polymerization or after the completion of such process. Suitable neutralizers include, but are not limited to, inorganic bases such as ammonia, sodium/potassium hydroxide, sodium/potassium carbonate or a combination. Organic bases such as dimethyl amine, diethyl amine, triethyl amine, monoethanolamine, triethanolamine, or a mixture thereof can also be used as the neutralizer. Among others, sodium hydroxide, ammonia, dimethylaminoethanol, 2-amino-2-methyl-1-propanol or any mixture thereof are preferable as the neutralizer useful for the polymerization process. Upon the addition of a neutralizer, pH of the final polymer shall be in the range of 6.0 to 10.0, preferably in the range of 7.0 to 9.5, more preferably in the range of 7.0 to 9.0.

The emulsion polymerization may be conducted either as a batch operation or in the form of a feed process (i.e. the reaction mixture is fed into the reactor in a staged or gradient procedure). Feed process is a preferred process. In such a process, optionally a small portion of the reaction mixture of the monomers may be introduced as an initial charge and heated to the polymerization temperature which usually will result in polymer seeds. Then the remainder the polymerization mixture of the monomers is supplied to the reactor. After the completion of the feeding, the reaction is further carried out for another 10 to 30 min and, optionally, followed by complete or partial neutralization of the mixture. After the completion of the first polymerization process, polymerization mixture of the second polymer monomers is supplied to the reactor in the same manner as described above. Upon the completion of the feeding, the polymerization is kept for another 30 to 90 min. Afterwards, the reaction mixture may be subject to oxidants, neutralizing agents, etc.

The present invention is further demonstrated and exemplified in the Examples, however, without being limited to the embodiments described in the Examples.

### Examples

Description of commercially available materials used in the following Examples:
Methyl methacrylate (MMA) (>99.8%, Tokyo Chemical Industry (TCI), Japan)
Styrene (>99.0%, TCI)
Butyl acrylate (BA) (>99.0%, TCI)
Sodium iodide (NaI) (>99.0%, Sigma-Aldrich, USA)
Potassium iodide (KI) (>99.5%, TCI)
Tetrabutylammonium iodide (BNI) (>98.0%, TCI)
FES-77 (33.0% of FES and 67.0% of water, BASF, Shanghai),
2,2′-azobis(2-methylpropionamide) dihydrochloride (V50) (95%, Wako Pure Chemical, Japan)
2-Hydroxyethyl 2-iodoisobutyrate (2-HEI) (>90.0%)
2-hydroxyethyl 2-iodo-2-phenylacetate (2-HEPhl) (>85.0%)

### Measurement Methods:

The number average molecular weight (Mₙ) and polydispersity determined by gel permeation chromatography (GPC) with DMF as an eluent. The GPC analysis using DMF as the eluent was performed on a Shimadzu (Kyoto, Japan) LC-2030C plus liquid chromatograph equipped with two Shodex LF-804 columns (300×8.0 mm; bead size=6 μm; pore size=3000 Å) and one KD-802 column (300×8.0 mm; bead size=6 μm; pore size=150 Å). The eluent (DMF) contained LiBr (10 mM). The flow rate was 0.34 mL/min (40° C.). The sample detection and quantification were conducted using a Shimadzu differential refractometer RID-20A. The column system was calibrated with standard poly(methyl methacrylate)s (PMMAs) or standard polystyrenes (PSts).

The average particle diameter as referred herein relates to the Z average particle diameter as determined by means dynamic light scattering (DLS). The measurement method is described in the ISO 13321:1996 standard. For this purpose, a sample of the aqueous polymer latex will be diluted and the dilution will be analysed. In the context of DLS, the aqueous dilution may have a polymer concentration in the range from 0.001 to 0.5% by weight, depending on the particle size. For most purposes, a proper concentration will be 0.01% by weight. However, higher or lower concentrations may be used to achieve an optimum signal/noise ratio. The dilution can be achieved by addition of the polymer latex to water or an aqueous solution of a surfactant in order to avoid flocculation. Usually, dilution is performed by using a 0.1% by weight aqueous solution of a non-ionic emulsifier, e.g. an ethoxylated C₁₆/C₁₈ alkanol (degree of ethoxylation of 18), as a diluent. Measurement configuration: HPPS from Malvern, automated, with continuous-flow cuvette and Gilson autosampler. Parameters: measurement temperature 20.0° C.; measurement time 120 seconds (6 cycles each of 20 s); scattering angle 173º; wavelength laser 633 nm (HeNe); refractive index of medium 1.332 (aqueous); viscosity 0.9546 mPa-s. The measurement gives an average value of the second order cumulant analysis (mean of fits), i.e. Z average. The “mean of fits” is an average, intensity-weighted hydrodynamic particle diameter in nm.

The monomer conversion percentage was determined with 1H NMR. The 1H NMR spectra were recorded on Bruker (Germany) AV500 spectrometer (500 MHZ) or AV300 (300 MHz) at ambient temperature. CDCl₃ (for purified polymers), acetone-d₆ (for crude methacrylate polymers), and tetrahydrofuran-ds (for crude styrene polymers) (Cambridge Isotope Laboratories, USA) were used as the solvents for the NMR analysis, and the chemical shift was calibrated using residual undeuterated solvents or tetramethylsilane (TMS) as the internal standard.

### General Procedure for Polymerization.

In a typical run, a mixture of a monomer (25.0 g, 30.0-50.0 wt %), an alkyl iodide initiator, an azo initiator, catalysts, emulsifier (e.g. FES-77, 1.7-10.0 wt %), and deionized water (44.4-66.7 wt %) was heated in a reaction vessel at 60-80° C. under argon atmosphere with mechanical stirring (1000 rpm). The vessel was a 100 mL jacketed cylindrical reaction vessel (ChemGlass, USA) connected with an overhead mechanical stirrer (Heidolph, Germany) and immersed in a water bath (Lauda, Germany). After a prescribed time t, an aliquot (2 mL) of the solution was taken out by a syringe, cooled to room temperature, and analyzed with GPC (DMF as eluent) and ¹H NMR.

The detailed information regarding the catalyst, the monomers, initiators, reaction time and temperature, etc and characterization of the polymer have been summarized in the following tables.

TABLE 1

| | Catalyst | [MMA]₀/[2-HEI]₀/ | | | conv | | PDI | | PDI |
|---|---|---|---|---|---|---|---|---|---|
| | A/B | [A]₀/[B]₀/[V50]₀ (mM) | T/° C. | t/min | (%) | Mₙ | (GPC) | d/nm | (DLS) |
| 1 | No | 8000/80/0/0/40 | 60 | 20 | 100 | 5250 | 2.39 | 105.9 | 0.045 |
| 2 | —/BNI | 8000/80/0/160/40 | 60 | 120 | 59 | 25700 | 1.30 | 158.9 | 0.033 |
| 3 | NaI/— | 8000/80/160/0/40 | 60 | 60 | 100 | 25200 | 1.54 | 96.86 | 0.064 |
| 4 | NaI/BNI | 8000/80/80/80/40 | 60 | 100 | 100 | 17100 | 1.33 | 167.0 | 0.029 |
| 5 | KI/BNI | 8000/80/80/80/40 | 60 | 100 | 100 | 16000 | 1.38 | 174.6 | 0.031 |

It's clear what when no water-soluble iodide salt nor organic-solvent-soluble iodine salt is present in the polymerization system, the overall PDI of the polymer is quite large. And, when the water-soluble iodide salt is missing the monomer conversion percentage is deteriorated while when the organic-solvent-soluble iodine compound is missing the PDI of the polymer is getting larger. This shows this reaction might be a typical CRP reaction.

TABLE 2

| | | [MMA]₀/[R—I]₀/[NaI]₀/ | | | conv | | PDI | | PDI |
|---|---|---|---|---|---|---|---|---|---|
| | R—I | [BNI]₀/[V50]₀(mM) | T/° C. | t/min | (%) | Mₙ | (GPC) | d/nm | (DLS) |
| 1 | 2-HEPhI | 8000/80/80/80/40 | 60 | 120 | 94 | 8800 | 1.20 | 201.5 | 0.034 |
| 2 | 2-IPhA | 8000/80/80/80/40 | 60 | 80 | 94 | 19100 | 1.40 | 139.6 | 0.042 |
| 3 | 2-HEPhI | 8000/40/160/160/20 | 60 | 240 | 100 | 18200 | 1.29 | 197.3 | 0.040 |

According to the data in Table 2, it's clear that many organic water-soluble iodine compounds are workable for the present invention.

TABLE 3

| | | Emulsifier/ | [Monomer]₀/[2-HEPhI]₀/ | | | conv | | PDI | | PDI |
|---|---|---|---|---|---|---|---|---|---|---|
| | Monomer | water (wt %) | [NaI]₀/[BNI]₀/[V50]₀ (mM) | T/° C. | t/h | (%) | Mₙ | (GPC) | d/nm | (DLS) |
| 1 | St | 10/60 | 8000/80/160/160/40 | 70 | 3 | 96 | 16400 | 1.25 | 246.0 | 0.031 |
| 2 | St | 10/60 | 8000/80/160/160/40 | 80 | 4 | 99 | 20000 | 1.27 | 706.4 | 0.025 |

The composition according to the present invention is also workable with different monomers (e.g. styrene).

TABLE 4

| | | Emulsifier/ | [Monomer]₀/[2-HEI]₀/ | | | conv | | PDI |
|---|---|---|---|---|---|---|---|---|
| | Monomer | water (wt %) | [BNI]₀/[NaI]₀/[V50]₀ (mM) | T/° C. | t/min | (%) | Mₙ | (GPC) |
| 1 | BA | 5/65 | 8000/80/320/320/27 | 70 | 20 | 79 | 19000 | 1.56 |
| | | | | | 25 | 99 | 21000 | 1.51 |
| 2 | BA | 5/65 | 8000/80/0/0/27 | 70 | 20 | 85 | 15000 | 1.55 |
| | | | | | 25 | 94 | 18000 | 1.57 |
| 3 | BA | 5/65 | 8000/80/80/80/40 | 70 | 30 | 100 | 21000 | 1.52 |

The composition according to the present disclosure is also workable without component B) or C) for monomers with more stable unsaturated bond such as acrylate monomers like BA. This shows this reaction might be a typical ITP reaction.

Therefore, it's obvious that the composition according to the present invention can be used in control polymerization, achieving high monomer conversion percentage, and resulting a polymer with small PDI and a polymer particle with low PDI.

1. A composition comprising:
A) at least one organic water-soluble iodine compound,
optionally
B) at least one organic-solvent-soluble iodide salt, and/or optionally
C) at least one water-soluble iodide salt,
wherein the at least one organic water-soluble iodine compound A) is represented by formula (1) 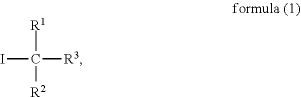
wherein R¹ is —COOX or —CONR⁴R⁵, and X is a hydrogen atom, an alkali metal, an alkaline earth metal, an organic ammonium, an ammonium, (CH₂CHR⁴O)ₙR⁵, or (CH₂CHR⁴O)ₙ(CH₂CHR⁶O)ₘR⁵, n and m are independent of each other an integer number in the range of 1 to 500, and R², R³, R⁴, R⁵ and R⁶ are independently of each other a hydrogen, an alkoxyl group/alkoxyl derivative, an aromatic group/aromatic derivative, or an aliphatic group/aliphatic derivative; meanwhile, R⁴ and R⁶ shall be different.

2. The composition according to claim 1, wherein the R¹ of formula (1) is selected from the group consisting of COOH, COOCH₂CH₂OH and COO(CH₂CH₂O)ₙCH₃, wherein n is a integer number in the range of 50 to 100.

3. The composition according to claim 1, wherein the R² and R³ of formula (1) are independently of each other a hydrogen, an alkyl group/alkyl derivative, an alkoxyl group/alkoxyl derivative, or an aryl group/aryl derivative.

4. The A composition according to claim 1, wherein the at least one organic-solvent-soluble iodide salt B) is selected from the group consisting of tetra-butylammonium iodide, tributylmethyl phosphonium iodide and tetra-n-octylammonium iodide.

5. The composition according to claim 1, wherein the at least one water-soluble iodide salt C) is selected from the group consisting of lithium iodide, sodium iodide, potassium iodide, calcium iodide and ammonium iodide.

6. The composition according to claim 1, wherein the at least one organic water-soluble iodine compound A) is selected from the group consisting of 2-iodoacetic acid, 2-iodopropionic acid, 2-iodopropionic acid amide, 2-iodo-2-methylpropionic acid, poly(ethylene glycol) methyl ether 2-iodoisobutyrate, 2-hydroxyethyl 2-iodoisobutyrate, 2-Iodo-2-phenylacetate, and 2-iodo-2-phenylacetic acid; the at least one organic-solvent-soluble iodide salt B) is selected from the group consisting of tetra-butylammonium iodide, tributylmethyl phosphonium iodide and tetra-n-octylammonium iodide; and at least one water-soluble iodide salt C) is selected from the group consisting of sodium iodide and potassium iodide.

7. The composition according to claim 1, wherein the weight ratio of A), B) and C) is in the ratio of 1:(0.1-40):(0.1-10).

8. The composition according to claim 1, wherein the at least one organic water-soluble iodine compound A) is presented in an amount of 2% to 85% by weight, the at least one organic-solvent-soluble iodide salt B) is presented in an amount of 8% to 80% by weight and the at least one water-soluble iodide salt C) may be presented in an amount of 8% to 20% by weight, all based on the total weight of the composition.

9. A method of using the composition according to claim 1, the method comprising using the composition in controlled living water-based emulsion polymerization, wherein the monomers applied in the emulsion polymerization include (meth)acrylate monomers, (meth)acrylonitrile monomers, styrene monomers, vinyl alkanoate monomers, monoethylenically unsaturated di- and tricarboxylic ester monomers, or monoethylenically unsaturated monomers containing at least one functional group selected from the group consisting of carboxyl, carboxylic anhydride, sulfonic acid, phosphoric acid, hydroxyl and amide, and a mixture thereof.

10. The method of use according to claim 9, wherein the monomers are selected from the group consisting of methyl (meth)acrylate, ethyl (meth)acrylate, n-butyl (meth)acrylate, 2-ethylhexyl (meth)acrylate, cyclohexyl (meth)acrylate, n-octyl (meth)acrylate, n-decyl (meth)acrylate, n-dodecyl (meth)acrylate (i.e. lauryl (meth)acrylate), tetradecyl (meth)acrylate, oleyl (meth)acrylate, palmityl (meth)acrylate, stearyl (meth)acrylate, isobornyl (meth)acrylate, benzyl (meth)acrylate, phenyl (meth)acrylate, styrene, α-methylstyrene, ortho-, meta- and para-methylstyrene, ortho-, meta- and para-ethylstyrene, o,p-dimethylstyrene, o,p-diethylstyrene, isopropylstyrene, o-methyl-p-isopropylstyrene, and mixtures thereof.

11. The method of use according to claim 9, wherein the at least one organic water-soluble iodine compound A) is used in an amount, based on the total weight of monomers, of 0.001% to 30% by weight.

12. The method of use according to claim 9, wherein the at least one organic-solvent-soluble iodide salt B is presented in an amount of, based on the total weight of monomers, of 0.01% to 40% by weight.

13. The method of use according to claim 9, wherein the at least one water-soluble iodide salt C) is presented in an amount of, based on the total weight of monomers, of 0.01% to 40% by weight.
